(19) United States
(12) Patent Application Publication
(10) Pub. No.: US 2014/0145578 A1
(43) Pub. Date: May 29, 2014

(54) SLIDER FOR SANITARY MODULE, AND SANITARY MODULE HAVING SLIDER

(71) Applicant: Geberit International AG, Jona (CH)

(72) Inventors: Alessandro TRECCO, Uerikon (CH); Michael SCHINTLER, Pfaffikon (CH)

(73) Assignee: Geberit International AG, Jona (CH)

(21) Appl. No.: 14/091,489

(22) Filed: Nov. 27, 2013

(30) Foreign Application Priority Data
Nov. 29, 2012 (EP) 12 194 817.8

(51) Int. Cl. A47B 88/04; F16C 29/00; F16C 29/04

(52) U.S. Cl. CPC A47B 88/04; F16C 29/04; F16C 29/001
USPC 312/334.1; 384/22; 384/18

(57) ABSTRACT

A slider (1) serves for the movable mounting of a sliding element (2) along a longitudinal direction in a stationary support structure (3) of a sanitary module (21). The slider (1) comprises a guide support (4), which is connectable to the support structure (3), and an assembly support (5), which is connected to the guide support (4) such that it is alignable in relation to the guide support (4), the assembly support (5) being connectable to the sliding element (2). The guide support (4) further comprises a first vertical linear guide (6), a second vertical linear guide (7) and a horizontal linear guide (8), via which linear guides the slider (1) is fastenable on the support structure (3).

### TECHNICAL FIELD

The present invention relates to a slider for the movable mounting of a sliding element, for example of a drawer, along a longitudinal direction in a stationary support structure of a sanitary module according to the preamble of Claim 1, and to a sanitary module having a sliding element and a slider according to the preamble of Claim 11.

### PRIOR ART

Sliders on cupboards are known from the prior art. Drawers are mounted on such sliders and are thereby displaceable in relation to the cupboard. The use of such cupboards has proven successful not only in kitchens but also in bathrooms. Here, the user can store his utensils in a simple and discreet manner in a drawer.

By way of example, EP 2 220 983 discloses a cupboard which is configured as a washstand. A drawer can be pulled out laterally from the washstand and is then readily accessible from the front. The drawer is alignable via a guide system. The guide system substantially comprises two vertical linear guides which lie in the vertical line and have a comparatively great length. On account of the great length, good guiding properties can indeed be provided, but the installation space is increased.

From the prior art the disadvantage further arises that, specifically in the case of sliding compartments which are of room height, the sliders represent a weak spot. When fully loaded, tilting of the drawer may occur in the extended state, the drawer then being movable only with difficulty.

### SUMMARY OF THE INVENTION

Proceeding from this prior art, the invention is based on an object of achieving a slider which overcomes the disadvantages of the prior art. In particular, the slider should be more compact while at the same time having the same or even improved guiding properties and load-bearing properties.

This object is achieved by the slider according to the subject matter of Claim 1. Correspondingly, a slider for the movable mounting of a sliding element along a longitudinal direction in a stationary support structure of a sanitary module comprises a guide support, which is connectable to the support structure, and an assembly support, which is connected to the guide support such that it is alignable in relation to the guide support. The assembly support is connectable to the sliding element of the sanitary module. The guide support further comprises a first vertical linear guide, a second vertical linear guide and a horizontal linear guide, via which linear guides the slider is fastenable on the support structure.

On account of the location in the vertical line of two guides which are loaded by the weight force of the slider, a particularly compact guide element can be provided. Furthermore, on account of the guide which lies in the horizontal line, guidance of the sliding element is additionally improved.

Preferably, the first vertical linear guide is longer than the second vertical linear guide. Consequently, the first vertical linear guide is not extended to its full length, this offering the advantage that it can bear a greater load. Moreover, the maximum extension can be defined by the shorter linear guide. On account of the arrangement of vertical guides of different lengths, the advantage arises that, in the event of a plurality of sliders being used in one sanitary module, the overall size of the sanitary module can be limited by clever arrangement of the first vertical guides in relation to one another, whereby the loading capacity of the sliding element can be increased at the same time.

Particularly preferably, the two vertical linear guides lie in the same plane or in parallel planes, this said plane or these said planes in the installed state lying in the vertical line. The horizontal linear guide lies in a plane which is perpendicular to the vertical linear guides. This plane in the installed state is the horizontal line.

Preferably, the vertical linear guides and the horizontal linear guide have the form of longitudinal guides having in each case two guide rails which are located movably in relation to one another via anti-friction elements, such as ball packets. One of the guide rails in each case is connectable to the support structure and the other of the guide rails in each case is connected to the guide support. The connection to the support structure may be direct or indirect.

Preferably, the guide support comprises a base plate, from which a leg projects perpendicularly, the two vertical linear guides being located on the base plate, and the horizontal guide being located on the leg, the base plate in the installed position lying in the vertical line and the leg in the installed position lying in the horizontal line.

Preferably, the assembly support comprises a base plate, from which at least one assembly leg projects angularly, preferably perpendicularly. The base plate lies flat against the base plate of the guide support and is preferably connected to the guide support via a screw connection.

Preferably, the assembly support is alignable in its position in relation to the guide support via at least one alignment element. As a result, the fitter on location can adjust the position of the sliding element in relation to the sanitary module or to the support structure by aligning the assembly support in relation to the guide support.

In a particularly preferred embodiment, the alignment element comprises at least one alignment edge on the assembly support and an eccentric element, which is pivotably mounted on the guide support, the eccentric element being in contact with the alignment edges and exerting an alignment movement on the assembly support.

The alignment elements are preferably located so that the sliding element can be aligned in all different directions. For this purpose, preferably three different alignment elements are provided.

In a preferred embodiment, the first vertical linear guide, the second vertical linear guide and the horizontal linear guide are connected to one another by a mounting element. Via this mounting element, the slider can be connected to the support structure in a simple manner. Particularly preferably, the mounting element has the form of a mounting plate having legs which are formed on and project angularly from the mounting plate, the slider being connectable to the support structure via the mounting plate.

A sanitary module, in particular for the fastening of a sanitary article, comprises a support structure made of profiles and décor elements, which are two-dimensional and connected to the profiles and which cover the support structure at least on the front side and the upper side. The sanitary module further comprises at least one sliding element, by which a slider according to the above description is connected to the support structure and is displaceable in relation to the support structure.

The guide support is preferably directly or indirectly fastened on the support structure via the vertical linear guides and the horizontal linear guide, and the sliding element is mounted with the assembly support on the slider.

In a particularly preferable embodiment, the sliding element, in addition to the slider, is mounted via a further horizontal guide in relation to the support structure.

Preferably, two sliding elements are located in relation to a vertical plane extending centrally through the sanitary module, said sliding elements being movable along an axis which is perpendicular to the vertical plane and extends in the horizontal line. The first vertical linear guides of the sliders in each case are offset in relation to one another in height and penetrate the vertical plane. The one linear guide thus penetrates the vertical plane from one side, and the other linear guide penetrates the vertical plane from the other side. As a result, the interior space in the sanitary module can be exploited in a particularly efficient manner, while still retaining the advantages of loading and guide length.

Preferably, the support structure further has fastening points for the fastening of the sanitary article on the sanitary module by means of fastening means which match the fastening points. The support structure may also have breakouts or ducts for the lead-through of pipelines for the connection to the sanitary fitting, the décor elements having or providing breakouts for the lead-through of the fastening means or the pipelines.

Further embodiments are provided in the dependent claims.

### BRIEF DESCRIPTION OF THE DRAWINGS

Preferred embodiments of the invention are described in the following by means of the drawings, which are merely explanatory and are not intended to be interpreted in a limiting manner. In the drawings:

FIG. 1 shows a perspective view of a sanitary module for receiving a sanitary article, the sanitary fitting comprising sliding elements;

FIG. 2 shows the view as in FIG. 1, without décor element and with an extended sliding element;

FIG. 3 shows a perspective view of a slider for the guiding and mounting of a sliding element, for example in a sanitary module as in FIG. 1;

FIG. 4 shows the slider as in FIG. 3 in the extended state;

FIG. 5 shows a front view of FIG. 3;

FIG. 6 shows a view of the sanitary module as in FIG. 1, without décor element, with closed sliding elements; and

FIG. 7 shows the view as in FIG. 6, with extended sliding elements.

### DESCRIPTION OF PREFERRED EMBODIMENTS

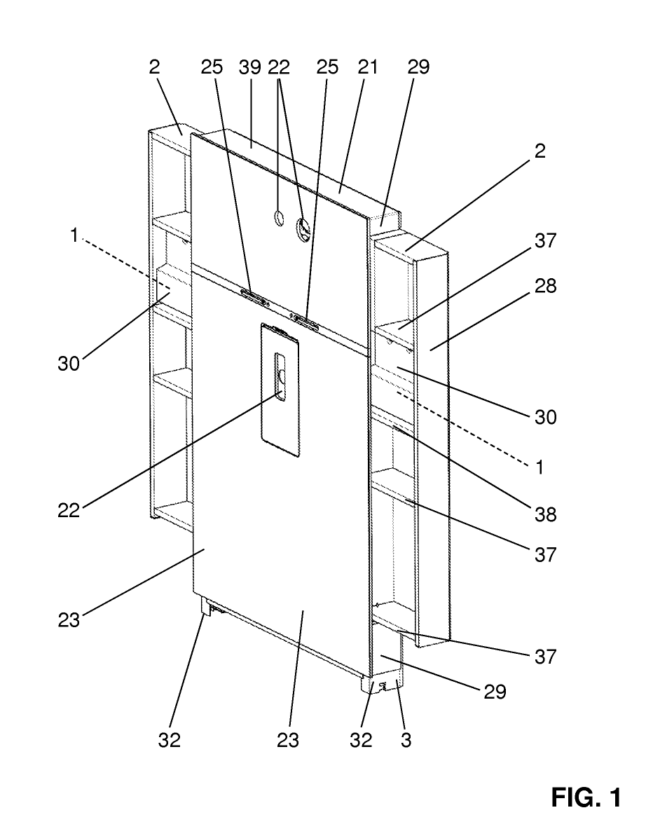

In FIG. 1 a sanitary module 21 having two sliding elements 2 is shown. The sliding elements 2 here have the form of drawers which can be pulled out laterally from the sanitary module 21. In FIG. 1, both drawers 2 are shown in the extended position. In the retracted position, the side face 28 of the sliding element 2 is flush with the side face 29 of the sanitary module 21. However, a single sliding element 2 may also be located here.

The sliding element 2 is mounted in relation to the sanitary module 21 by a slider 1 according to the invention, said slider 1 in FIG. 1 being covered by a cover 30 and thus not being visible. On account of the cover 30 and the location of the slider 1 in the sliding element 2, the technical details cannot be seen by the user, which provides a particularly aesthetic solution.

The sanitary module 21 substantially comprises a support structure 3 and décor elements 23, 39. The décor element 23 conceals the support structure 3 on the front side, and the décor element 39 conceals the support structure 3 on the upper side. Furthermore, the side faces 29 are also to be understood to be décor elements. The décor elements 23, 39 can be fastened on the support structure 3.

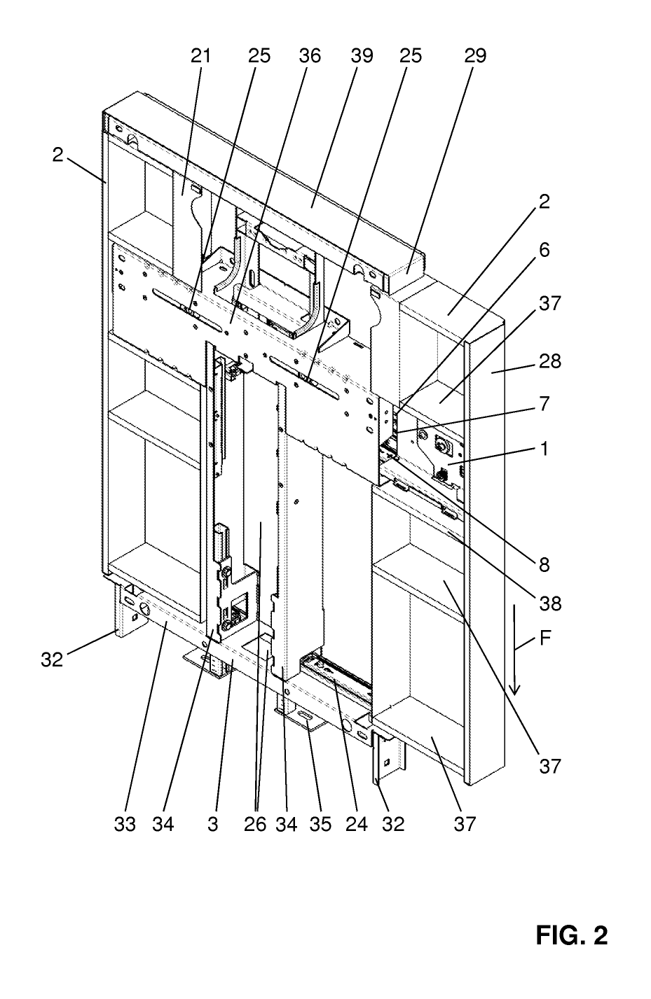

In FIG. 2, the sanitary module 21 according to FIG. 1 is shown without the décor element 23 on the front side, as a result of which the support structure 3 becomes visible. The support structure 3 provides a supporting structure for a multiplicity of elements and is mostly erected on the floor of a bathroom. In FIG. 2, the right-hand sliding element 2 is shown in the extended position, while the left-hand sliding element 2 is shown in the closed position. Both, the left-hand and also the right-hand sliding element 2 are connected in each case by one slider 1 to the support structure 3. The slider 1 serves here for the mounting of the sliding element 2 in relation to the support structure 3 and also for providing the corresponding displacement movement from the closed position into the extended position.

In a particularly preferred embodiment, the slider 1 is configured to be adjustable, so that the sliding element 2 is alignable in relation to the support structure 3 or to the sanitary module 21, so that the side face 28 is flush with the side face 29 and, moreover, comes to lie in the same plane.

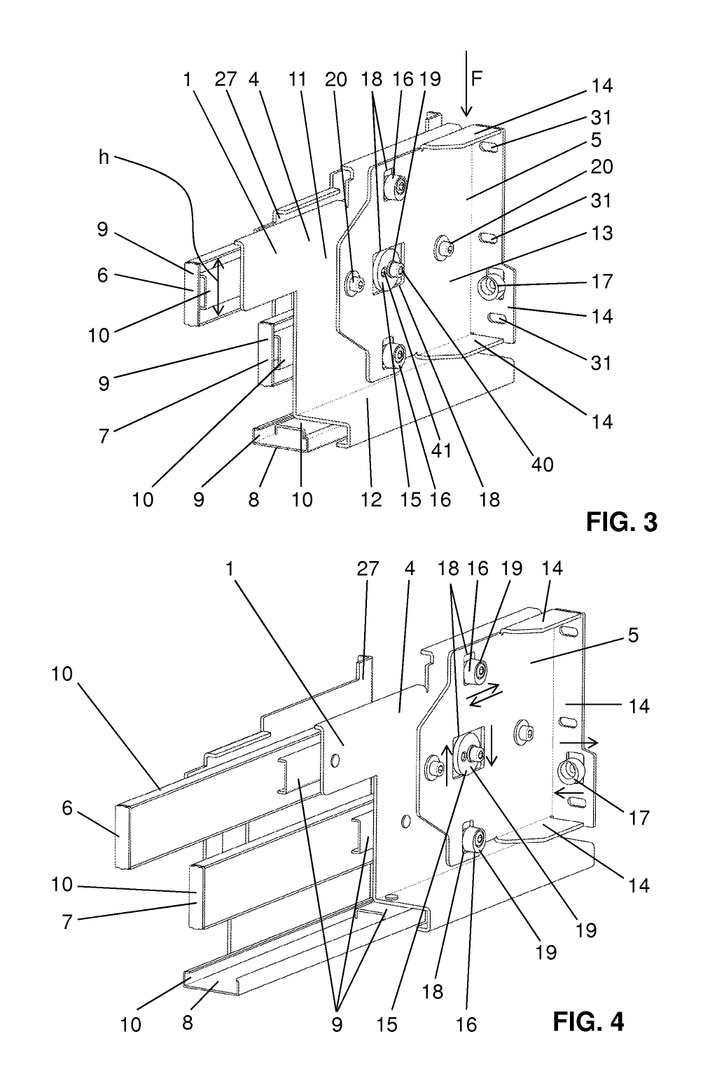

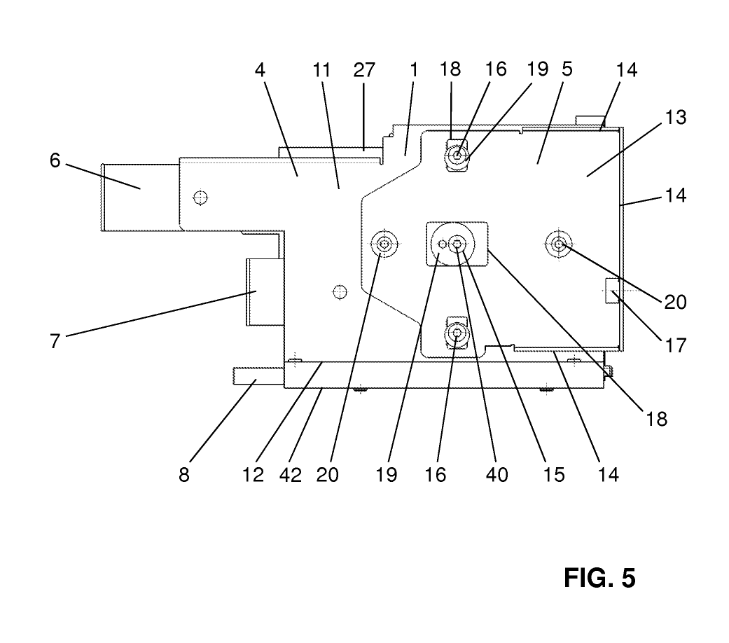

With reference to FIGS. 3 to 5, the slider 1 for the movable mounting of the sliding element 2 in the stationary support structure 3 of the sanitary module 21 will be explained.

The slider 1 comprises a guide support 4 and an assembly support 5. The assembly support 5 is connected here to the guide support 4, the position of the assembly support 5 being alignable in relation to the guide support 4.

The assembly support 5 is connectable to the sliding element 2, as will be explained hereunder.

The guide support 4 is connected by a plurality of linear guides 6, 7, 8 to the support structure 3 directly or indirectly via further elements. A first vertical linear guide 6, a second vertical linear guide 7 and a horizontal linear guide 8 are located on the guide support 4. Irrespective of whether a vertical linear guide 6, 7 or a horizontal linear guide 8, the term linear guide is meant to be understood in the present context as a guide structure which provides the movement along a longitudinal axis.

The location of two vertical linear guides 6, 7 and one horizontal guide 8 has the advantage that the weight force of the sliding element 2 acting on the slider 1 can be borne particularly well. In FIG. 3, the weight force is identified by the arrow F. The weight force acts from the sliding element 2 via the assembly support 5 on the guide support 4 and on the guides 6, 7, 8.

The two vertical linear guides 6, 7 stand here in the vertical line such that the force F generates a bending moment across the height h of the linear guide. The two vertical linear guides 6, 7 here stand such that they oppose the force F, which runs along the vertical line, with a high bending-resistance moment. In other words, in terms of their cross section, the two vertical linear guides 6, 7 stand upright.

The horizontal linear guide 8, however, substantially serves for guiding the sliding element in the horizontal plane which is perpendicular in relation to the force F running in the vertical line. In relation to the force F, the horizontal linear guide 8 stands such that it opposes the force F with a smaller bending-resistance moment than the vertical linear guides 6 or 7.

The two vertical linear guides 6, 7 are of different lengths. The first vertical linear guide 6 is configured here longer than the second vertical linear guide 7. The second vertical linear guide 7, that is to say the shorter linear guide 7, with its effective region defines the maximum extension of the slider 1 out of the sanitary module 21. The linear guide 7 thus also defines the stop for the sliding element 2. In terms of the length of the first vertical linear guide 6, this means that said linear guide 6 is not extended to its maximum, even when the sliding element is extended to its maximum, as illustrated in FIG. 4. Consequently, the individual parts of the first linear guide 6 are in contact over a relatively great guiding length, and the force F can be absorbed better.

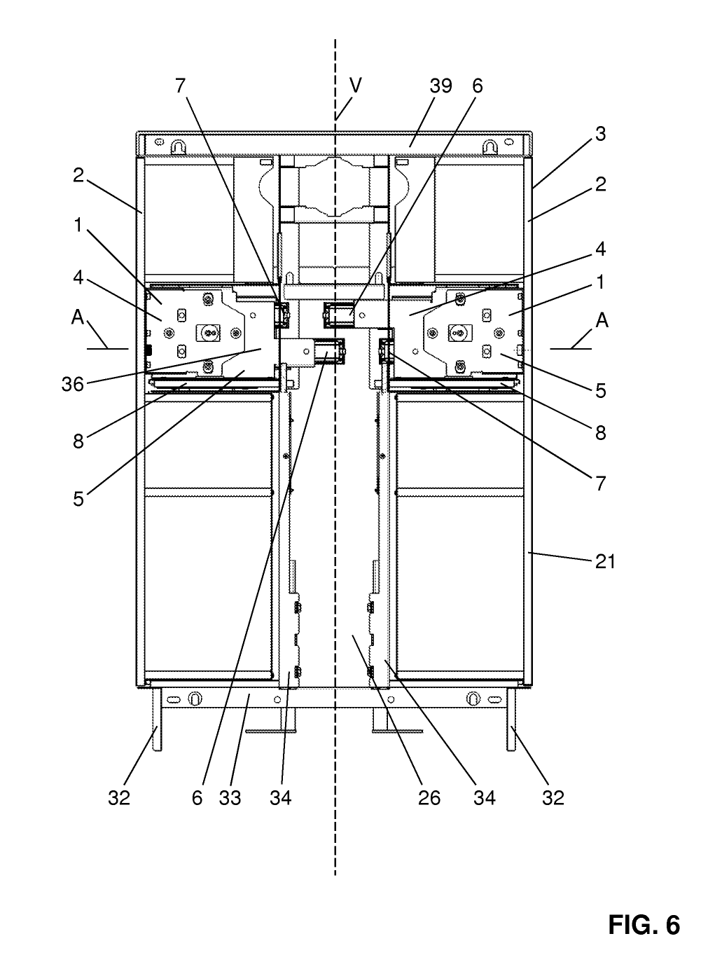

Furthermore, the configuration of the vertical linear guides 6, 7 has the advantage that, along with improved force absorption, the limited space in the sanitary module 21 is optimally used, as will be explained further down by means of FIG. 6.

The two vertical linear guides 6, 7 lie here in the same plane, but may also be located in planes which extend parallel to one another. In the installed state, this plane or these planes lie in the vertical line. The vertical line is defined here such that it lies parallel to the weight force F of the sliding element 2. The vertical plane is, therefore, substantially parallel to the force of gravity. The horizontal linear guide 8 lies here in the horizontal line, which lies perpendicularly to the vertical line.

The vertical linear guides 6, 7 and the horizontal linear guide 8 in the present embodiment have a substantially identical design, apart from the installed position. The linear guide 6, 7, 8 comprises two guide rails 9, 10, which extend parallel to one another and are displaceable in relation to one another. Particularly preferably, the guide rail 10 is mounted in the guide rail 9 via anti-friction elements which are not illustrated here. By way of example, ball packets may be provided as anti-friction elements. On account of its mounting within the guide rail 9, the guide rail 10 may also be described as an inner guide rail 10, with the guide rail 9 being described as an outer guide rail.

The inner guide rails 10 of the linear guides 6, 7, 8 are connected here to the guide support 4; for example via a screw connection.

The outer guide rails 9 serve for the connection of the slider 1 to the sanitary module 21, in particular with the support structure 3. The connection to the support structure 3 may take place directly. Here, the outer guide rails 9 are connected directly to the support structure 3. In an alternative and particularly preferred embodiment, the outer guide rails 10 are connected to a mounting plate 27. The outer guide rails 10 are preferably screwed onto the mounting plate 27. The mounting plate 27 for its part is then connected to the support structure 3 of the sanitary module 21, preferably via a screw connection. This embodiment having the mounting plate 27 has the advantage that the sliding element 2 can be provided as a unit which is connectable to the support structure 3 in a few steps. The mounting plate can be seen particularly well in FIG. 4, which shows the slider in the extended position.

The guide support 4 comprises a base plate 11, from which a leg 12 projects perpendicularly. In the installed state, the base plate 11 lies parallel to the vertical plane, and the leg 12 extends parallel to the horizontal plane. Correspondingly, the two vertical linear guides 6, 7 are located on the base plate 11, and the horizontal linear guide 8 is located on the leg 12.

The assembly support 5 comprises a base plate 13. From this base plate 13, at least one assembly leg 14 projects angularly. The assembly legs 14 are preferably perpendicular here in relation to the base plate 13. Three assembly legs 14 are located in the present embodiment. Here, two of the assembly legs 14 lie parallel to the horizontal plane, and one of the assembly legs 14 lies parallel to the vertical plane. The assembly legs 14 may be provided with assembly openings 31, through which a screw for the fastening of the slider on the sliding element 2 can be guided.

The base plate 13 of the assembly support 5 lies flat against the base plate 11 of the guide support 4. The two base plates 11 and 13 are fixedly connected to one another. In the present embodiment, the connection is provided via a screw connection 20. The screw connection 20 has the advantage that a fitter can align the two base plates in relation to one another so that the sliding element 2 can be aligned in relation to the support structure 3 or to the sanitary module 21 in order to achieve the flush fit of the side faces 28, 29.

For the alignment, preferably at least one alignment element 15, 16, 17 is present, there being three here, via which the assembly support 5 is alignable in relation to the guide support 4. Consequently, the sliding element 2 can be aligned in relation to the support structure 3 or to the sanitary module 21 via the alignment element 15, 16, 17. Upon completion of the alignment, the guide support 4 and the assembly support 5 are secured in relation to one another via the screw connection 20.

Three alignment elements 15, 16, 17 are located in the present embodiment. Each of the alignment elements 15, 16, 17 comprises at least one alignment edge 18 on the assembly support 5, and an eccentric element 19, which is pivotably mounted on the guide support 4, which eccentric element 19 is in contact with the alignment edges 18. Preferably, the alignment edges 18 completely surround the eccentric element 29. The eccentric element 19 is configured here as a circular disc which can be turned about a pivot point 40 which is located outside the central axis of the disc. Consequently, the distance between the pivot point 40 and the alignment edge 18 changes when there is a pivoting adjustment of the eccentric element 19. In this case, the assembly support 5 is displaced in relation to the guide support 4. The eccentric element 19 has a tool opening 41 so that the fitter can make the pivoting adjustment with a tool.

A first alignment element 15 serves for the alignment of the height of the sliding element 2. In the installed position, the first alignment element 15 thus pushes the assembly support 5 in the vertical direction in relation to the guide support 4. This is illustrated by the two arrows in the region of the alignment element 15 in FIG. 4.

The slider 1 further comprises a second alignment element 16, with which the sliding element 2 is alignable in its inclination in relation to the horizontal line. The second alignment element 16 here comprises two eccentric elements 19. Furthermore, via the two alignment elements 16 the assembly support 5 can be displaced in relation to the guide support 4 along a direction in the horizontal line.

The third alignment element 17 serves for the alignment of the inclination in relation to the vertical line, the third alignment element 17 being connected to the slider 1 either directly or via a plate, which is not shown.

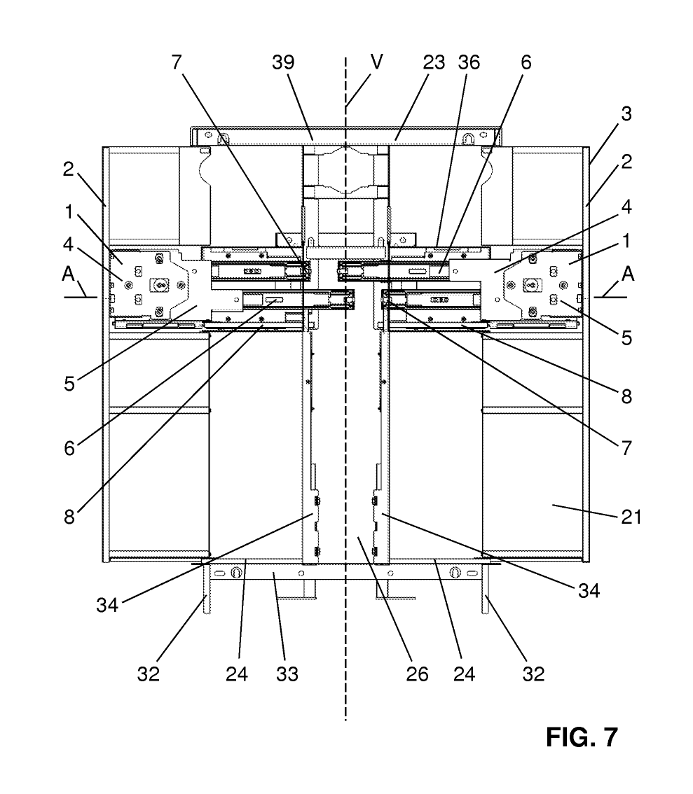

With reference to FIGS. 2, 6 and 7, details of the sanitary module 21 or the support structure 3 will now be explained more precisely. In FIG. 6, the two sliding elements 2 are in the retracted position. In FIG. 7, the two sliding elements 2 are in the extended position.

The support structure 3 is made of a plurality of profiles, which are connected to one another. The configuration of the various profiles may be solved in many ways.

In the present embodiment, the support structure 3 comprises vertically running support profiles 32, which are connected to one another by a cross member 33. Two vertical profiles 34, which are located spaced apart from one another, are located in relation to a plane V extending centrically and perpendicularly in relation to the profile axis through the cross member 33 and in the installed direction lying in the vertical line. These vertical profiles 34 are, moreover, connected to the floor via support elements 35. Spaced apart from the cross member 33, the support structure 3 further comprises a transverse support 36, which is connected to the vertical profiles 34 and lies spaced apart in relation to the cross member 33.

This transverse support 36 is configured here substantially as a rectangular hollow profile having an interior space. In the interior space, the transverse support 36 is connected to the guides 6, 7, 8 or to the mounting plate 27 of the slider 1. The transverse support 36 serves for the fastening of the slider 1 on the support structure 3. Consequently, the sliding element 2 is connected by the slider 1 in relation to the support structure 3. On account of the properties of the slider 1, the sliding element 2 is movable in relation to the support structure 3 along the longitudinal movement in the horizontal line.

The two vertical profiles 34 extend from the transverse support further upward, where they are then covered by an upper décor element 39.

From FIG. 2 it is further evident that, in addition to the slider 1, the sliding element 2 is mounted on the support structure via an optional horizontal guide 24. The horizontal guide 24 is located here in the region of the cross member 33. This optional horizontal guide 24 has proven particularly advantageous when the sliding element 2 has a comparatively large height.

With reference to FIG. 6 it is evident that two sliding elements 2 are located in relation to a vertical plane V which runs centrally through the sanitary module 21. These sliding elements 2 are movable along an axis A, which is perpendicular to the vertical plane V and extends in the horizontal line, and are in each case mounted by a slider 1 in relation to the support structure 3.

The first vertical linear guide 6 of the slider 1 which is located on the right is offset here in its height in relation to the first vertical linear guide of the slider 1 which is located on the left. On account of this offset, the first vertical linear guides 6 can penetrate the vertical plane V. This arrangement has the particular advantage that the first vertical linear guides 6 can be selected to be longer without the width of the sanitary module 21 having to be enlarged. As already mentioned above, the first vertical linear guides 6 are not extended to their full length. As a result, while maintaining the same compactness, the sliding element 1 can be loaded with a greater force on account of the greater guide length of the vertical linear guide.

In the present embodiment according to FIGS. 2, 6 and 7, the sliding element 2 has the form of a sliding drawer having three shelves 37 which can be used by the user. A fourth shelf 38 is provided, the slider 1 being located above said shelf 38. It is evident particularly well from FIG. 1 that this slider 1 is covered by a cover 30, so that the user cannot see it. The cover 30 is attached after adjustment of the sliding element 2 in relation to the sanitary module 21 via the alignment elements 16, 17, 15, and can be removed again in the event of maintenance.

The support structure 3 further has fastening points 25 for the fastening of the sanitary article on the sanitary module 21 or on the support structure 3. By way of example, the fastening points 25 may be threaded openings. Particularly preferably, the threaded openings are part of a separate element which is movable with the support structure. By means of fastening means which match the fastening points 25, the sanitary article can thus be fastened on the sanitary module 21.

The support structure 3 further has breakouts or ducts 26 for the lead-through of pipelines for the connection to the sanitary fitting. The pipelines are led through these breakouts or ducts 26 to the corresponding point on the sanitary module 21. Furthermore, the décor elements, here the décor element 23 on the front side, have breakouts 22 through which corresponding pipelines can be led out from the support structure 3 through the décor element 23 to the sanitary article. The breakouts 22 also serve for the lead-through to the sanitary fitting described above.

Particularly preferably, the sanitary module 21 additionally comprises a push-to-open module which, upon pressure being applied on the closed sliding elements 2, opens the latter. This module may be provided separately or else be an integral component of the linear guide.

### LIST OF REFERENCE SIGNS

1 Slider
2 Sliding element
3 Support structure
4 Guide support
5 Assembly support
6 First vertical linear guide
7 Second vertical linear guide
8 Horizontal linear guide
9 Inner guide rail
10 Outer guide rail
11 Base plate
12 Leg
13 Base plate
14 Assembly leg
15 Alignment element
16 Alignment element
17 Alignment element
18 Alignment edge
19 Eccentric element
20 Screw connection
21 Sanitary module
22 Breakouts
23 Décor element
24 Horizontal guide
25 Fastening points
26 Breakouts
27 Mounting plate
28 Side face
29 Side face
30 Cover
31 Assembly opening
32 Support profiles
33 Cross member
34 Vertical profiles
35 Support elements
36 Transverse support
37 Shelf
38 Shelf
39 Décor element
40 Pivot point
41 Tool opening
42 Leg
V Vertical line
H Horizontal line

1. Slider (1) for the movable mounting of a sliding element (2) along a longitudinal direction in a stationary support structure (3) of a sanitary module (21), comprising
a guide support (4), which is connectable to the support structure (3), and
an assembly support (5), which is connected to the guide support (4) such that it is alignable in relation to the guide support (4), the assembly support (5) being connectable to the sliding element (2), characterized in that
the guide support (4), comprises a first vertical linear guide (6), a second vertical linear guide (7) and a horizontal linear guide (8), via which linear guides (6, 7, 8) the slider (1) is fastenable on the support structure (3).

2. Slider (1) according to claim 1, characterized in that the first vertical linear guide (6) is longer than the second vertical linear guide (7).

3. Slider (1) according to one of the preceding claims, characterized in that the two vertical linear guides (6, 7) lie in the same plane or in parallel planes, this plane or these planes in the installed state lying in the vertical line and in that the horizontal linear guide (8) lies in a plane which is perpendicular to said plane having the vertical linear guides (6, 7), the former plane in the installed state corresponding to the horizontal line.

4. Slider (1) according to one of the preceding claims, characterized in that the vertical linear guides (6, 7) and the horizontal linear guide (8) have the form of longitudinal guides having at least two guide rails (9, 10) which are located movably in relation to one another via anti-friction elements, such as ball packets, one of the guide rails (9, 10) in each case being connectable to the support structure (3) and the other of the guide rails (9, 10) in each case being connected to the guide support (4).

5. Slider (1) according to one of the preceding claims, characterized in that the guide support (4) comprises a base plate (11), from which a leg (12) projects perpendicularly, the two vertical linear guides (6, 7) being located on the base plate (11), and the horizontal guide (8) being located on the leg (12), the base plate (11) in the installed position lying in the vertical line and the leg (12) in the installed position lying in the horizontal line.

6. Slider according to one of the preceding claims, characterized in that the assembly support (5) comprises a base plate (13), from which at least one assembly leg (14) projects angularly, preferably perpendicularly, the base plate (13) lying flat against the base plate (11) of the guide support (4) and preferably being connected to the guide support (4) via a screw connection (20).

7. Slider according to one of the preceding claims, characterized in that the assembly support (5) is alignable in its position in relation to the guide support (4) via at least one alignment element (15, 16, 17).

8. Slider according to claim 7, characterized in that the alignment element (15, 16, 17) comprises at least one alignment edge (18) on the assembly support (5) and an eccentric element (19), which is pivotably mounted on the guide support (4), the eccentric element (19) being in contact with the alignment edges (18) and exerting an alignment movement on the assembly support (5).

9. Slider according to either of claims 7 or 8, characterized in that at least one alignment element (15) is located for the alignment of the height, in that at least one alignment element (16) is located for the alignment of the inclination and position in relation to the horizontal line, and in that at least one alignment element (17) is located for the alignment of the inclination in relation to the vertical line.

10. Slider according to one of the preceding claims, characterized in that the first vertical linear guide (6), the second vertical linear guide (7) and the horizontal linear guide (8) are connected to one another by a mounting element (27), preferably in the form of a mounting plate (27) having legs (42) which are formed on and project angularly from the mounting plate (27), the slider being connectable to the support structure (3) via the mounting plate (27).

11. Sanitary module (21), in particular for the fastening of a sanitary article, comprising a support structure (3) made of profiles (32-36) and décor elements (23), which are two-dimensional and connected to the profiles (32-36) and which cover the support structure (3) at least on the front side and the upper side, the sanitary module (21) further comprising at least one sliding element (2), which by a slider (1) according to one of the preceding claims is connected to the support structure (3) and is displaceable in relation to the support structure (3).

12. Sanitary module (21) according to claim 11, characterized in that the guide support (4) is directly or indirectly fastened on the support structure (3) via the vertical linear guides (6) and the horizontal linear guide (8), and the sliding element (2) is mounted by the assembly support (5) on the slider (1).

13. Sanitary module (21) according to either of claims 11 and 12, characterized in that the sliding element (2), in addition to the slider (1), is mounted via a further horizontal guide (24) in relation to the support structure (3), the two horizontal guides (8, 24) being spaced apart from one another in the horizontal line.

14. Sanitary module (21) according to one of claims 11 to 13, characterized in that two sliding elements (2) are located in relation to a vertical plane (V) extending centrally through the sanitary module (21), said sliding elements (2) being movable along an axis (A) which is perpendicular to the vertical plane (V) and extends in the horizontal line, the first vertical linear guides (6) of the sliders (1) in each case being offset in relation to one another in height and penetrating the vertical plane (V).

15. Sanitary module (21) according to one of the preceding claims 11 to 13, characterized in that the support structure (3) further has fastening points (25) for the fastening of the sanitary article on the sanitary module (21) by means of fastening means which match the fastening points (25) and/or in that the support structure (3) has breakouts or ducts (26) for the lead-through of pipelines for the connection to the sanitary fitting, the décor elements (23) having or providing breakouts (22) for the lead-through of the fastening means or the pipelines.
